(19) United States
(12) Patent Application Publication
(10) Pub. No.: US 2015/0122763 A1
(43) Pub. Date: May 7, 2015

(54) SYSTEM FOR LOADING AND UNLOADING IN PORT OPERATIONS , COMPRISING OF A CRANE; AND A BASE LOCATED IN THE BODY OF THE CRANE THAT HOLDS AND STOCKS THE HATCH COVERS

(71) Applicant: Guillermo Bobenrieth Giglio, Santiago (CL)

(72) Inventor: Guillermo Bobenrieth Giglio, Santiago (CL)

(21) Appl. No.: 14/398,881

(22) PCT Filed: May 2, 2013
(86) PCT No.: PCT/CL2013/000027

§ 371 Date: Nov. 4, 2014

(30) Foreign Application Priority Data
May 4, 2012 (CL) 201201183

(51) Int. Cl. B66C 19/00; B65G 67/60

(52) U.S. Cl. CPC B66C 19/002; B65G 67/60
USPC 212/343

(57) ABSTRACT

The invention relates to a system (I) for loading and unloading during port operations and equipment for supporting hatchway covers (II) of marine-vessel holds, comprising: a loading and unloading crane (2); and a base located in the body of the crane for supporting and stacking the hatchway covers (II). The invention also relates to a method for removing, stacking and returning hatchway covers in said system (I) for loading and unloading during port operations and equipment for supporting hatchway covers (II) of marine-vessel holds, comprising: i) having said system (I) available; ii) removing the hatchway cover from the hold and moving it using the carriage (9) of the crane; iii) transferring the cover and placing it on the base installed in the body of the crane; and iv) returning the cover to the vessel, transferring same from said base to the vessel, once the loading and/or unloading operation has been completed.

### FIELD OF THE INVENTION

The invention is related with the tasks of loading and unloading of ships or boats, and is specifically related with the procedure for removal of the hatch covers to allow access or exit of the cargo to the holds of the maritime vessels.

The invention consists of a system of loading, unloading and supporting the hatch covers, which comprises a crane and a base for stacking the hatch covers of the ship, so that these covers are not stockpiled somewhere else that it can be used for other operation.

### BACKGROUND OF THE INVENTION

The holds of ships or boats are the space inside the hull which is used to hold the cargos that are transported. The opening that allows access to the hold for introducing or removing the cargos is the hatch, which in most cases is on the deck of the ship which is the upper outer surface of the hull. When the ship sails these hatches must be closed, both to protect the cargo, and to maintain the water-tightness of the ship and so to not allow water to enter the holds filled with water. The element that closes the hatch is called the hatch cover and should be tight enough so as not to allow water to enter which eventually passes on the deck of the ship during navigation.

During the tasks of loading and unloading of the ships the hatch covers have to be removed from the hatches to allow access or egress of the cargo to the holds. Some ships are equipped with devices for opening and closing the hatch and have sufficient space to retain the hatch cover on the ship once it is removed from the hatch; while other ships neither have the space nor have the devices that will allow them to retain the covers on them, so they must be removed and placed elsewhere, which in most cases is the surface of the docks, breakwaters or rafts used for loading or unloading of the goods.

When hatch covers have to be removed from the boats and arranged on the surface of the docks, breakwaters or rafts or any other surface which is used for this purpose and which is not the ship, the area used may have alternative uses such as gathering the cargos or the transit of the equipment transfer or transportation of goods. In some cases these areas may be critical for efficient operation of transfer and portage (transport of cargo within the port or maritime terminal) of the cargos.

In view of the above, it is necessary to have a place to put the hatch cover, which is other than the surface of the docks, breakwaters or rafts, and which has easy accessibility and adequate capacity. In this way, the hatch covers of the ship would not occupy the area of operation where the cargo or other items can be gathered, used for the transit of the portage equipment or to locate the transfer equipments.

The applicant has developed a system to store or stack the hatch covers, within the same crane that performs the loading and unloading of the goods contained in the holds of ships

The document U.S. Pat. No. 5,538,382 describes a system consisting of a crane that has a variable level suspended platform lift type having a mechanism for lifting, wherein said platform is for the transport of the cargo.

The document U.S. Pat. No. 4,858,775 describes a platform lift for the load of a container, which includes its own circulation engines motion to have autonomy of movement along the crane boom.

From the state of the art it can be seen that although there exist platforms associated with loading cranes, these platforms are with elevator movement and are installed on the cranes to assist with the loading and unloading processes in the maritime operations.

The objective of the present invention is to provide a means for gathering the hatch covers, so that the hatch covers are not stacked or stored on the surface of the docks, breakwaters or rafts used for loading or unloading of the goods.

### SUMMARY OF THE INVENTION

The present invention corresponds to a system for loading, unloading in port operations and for supporting hatch covers comprising a crane for loading and unloading of maritime operations and a base located in the body of the crane to hold and stack the hatch covers.

### BRIEF DESCRIPTION OF THE DRAWINGS

The invention will be described below with reference to the accompanying drawings, in which:

FIG. 1 shows a side-rear view of the system of the present invention.

FIG. 2 shows a side-front view of the system of the present invention.

FIG. 3 shows a side-rear view for the other side of the system of the present invention.

FIG. 4 shows a side view of the outer platform option of the system of the present invention.

FIG. 5 shows a side view of FIG. 1.

FIG. 6 shows a front view of the system with platform or with one support.

FIG. 7 shows a top view of the system of the present invention with stacked covers.

FIG. 8 shows another side view of the system of the present invention.

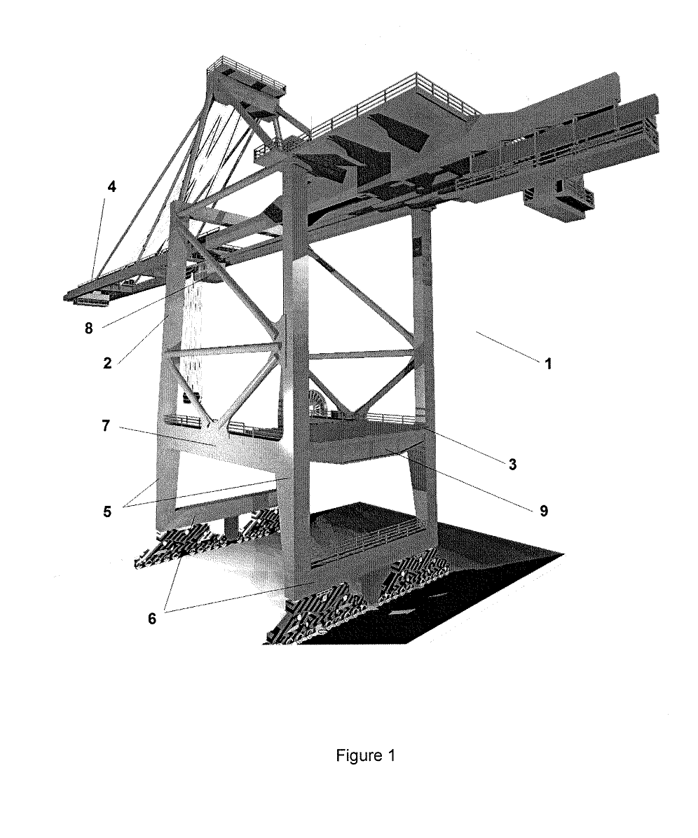

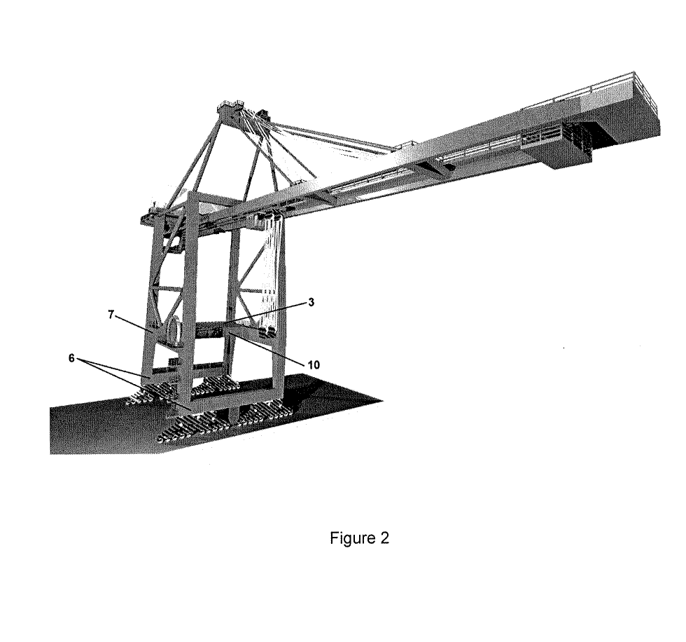

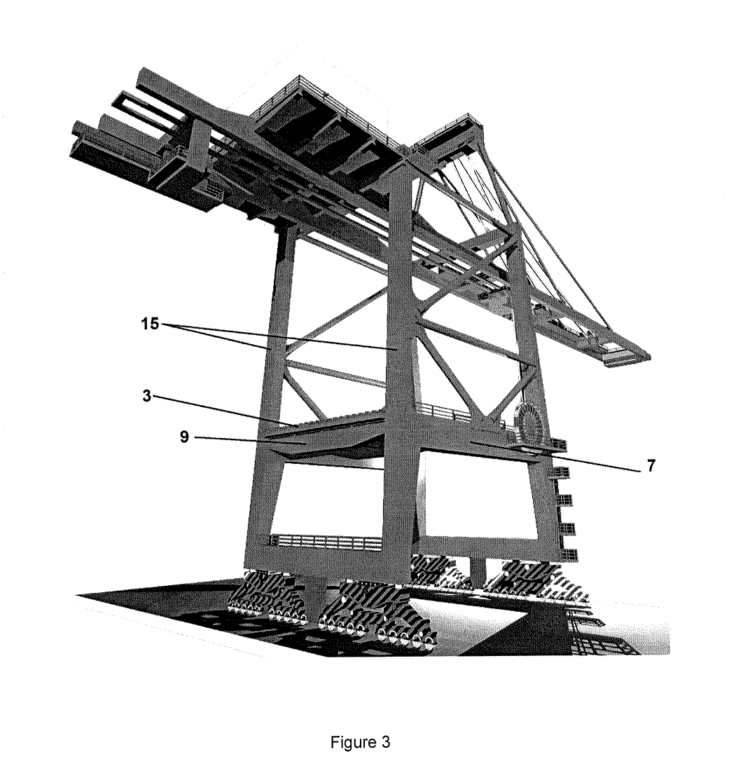

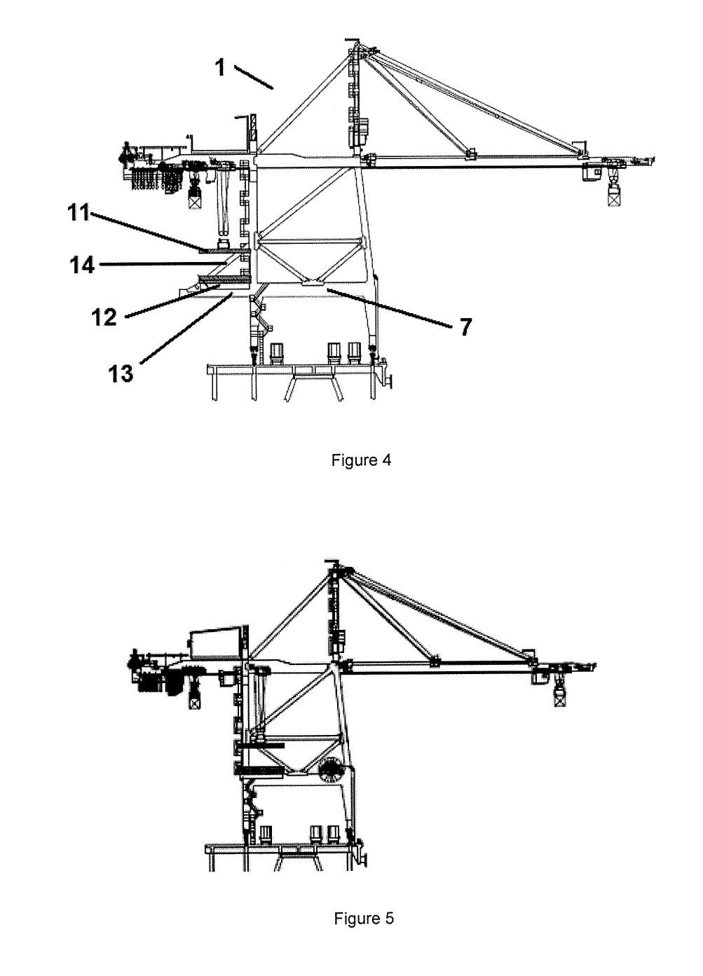

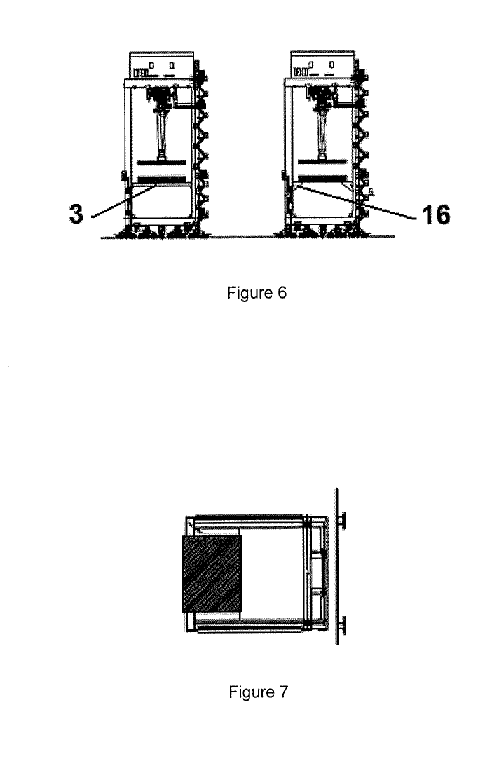

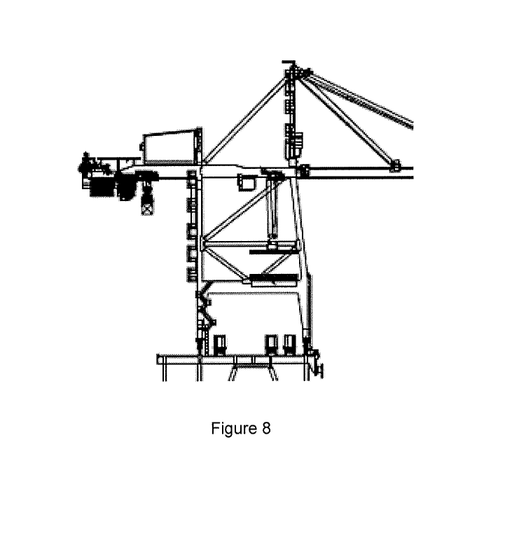

### DETAILED DESCRIPTION OF THE INVENTION

The present invention corresponds to a system (1) for loading, unloading in port operations and for supporting hatch covers (11) comprising a crane (2) for loading and unloading of maritime operations and a base to be located in the body of the crane for holding and stacking the hatch covers.

The crane (2) for loading and unloading in port operations corresponds to a gantry crane that has an elevated bridge (4) or a gantry supported by two legs (5) by way of an angled arch (15) formed by two verticals profiles, wherein each leg terminates in a horizontal profile base (6); in the bottom half of the legs two lateral horizontal beams are located (7), one on each side of the body of the crane, which links both legs of the crane on their lateral sides, allowing the crane to have free movement of jib trolley (8) in the front and back direction of the crane.

The base to be placed in the body of the crane can be a platform with supports (3, 12) or only a cover support (16, 13) said base is of a resistant material, preferably metal and is strongly adhered to the lateral horizontal beams (7) and/or to the verticals profiles of the legs of the crane, either joined by welding and/or bolted. The installation of the base in the crane (2) may be made on the inside of the body of the crane between its legs or on the outside of the body of the crane as a horizontal extension.

The installation of the platform (3) on the inside of the body of the crane comprises installing small supports attached strongly to the lateral horizontal beams (7) of the crane; a rear horizontal beam (9) attached to the vertical profiles of the rear leg; a front horizontal beam (10) attached to the lateral horizontal beams; and a platform (3) placed on the supports and the front and rear horizontal beams (10.9), tightly bound. The installation of the outer platform (12) on the outside of the body of the crane comprises installing supports attached to the vertical profiles of the legs of the crane and a platform on said supports, also includes some higher tensors (14) attached to the top of the crane. The installation of the supports (16) on the inside of the body of the crane comprises placing supports attached to the lateral horizontal profiles where such supports are of an adequate size and sufficient to support the weight of the hatch covers (11). The installation of the outer cover support (13) on the outside of the body of the crane comprises only installing supports attached to the vertical profiles of the legs of the crane, also including some higher tensors (14) attached to the top of the crane.

The distance between the legs of the crane is about 17 meters and the size of the hatch covers is about 12 to 13 meters, so the size of the platform (3) or the outer platform (12) or the support (16) or the outer cover support (13) has a length of about 14 to less than 17 meters and a width of approximately 10 to 14 meters. The thickness of the inner or outer platform is in the range of 1.20 meters to less than 30 cm.

Optionally the platform (3) or support (16) contains flanges or wedges to make the operation safer.

The procedure of removing, stacking and returning of the hatch covers to the ship comprises:

1. having a system (1) of loading, unloading and supporting hatch covers (11);

2. removing the hatch cover from the hold of the maritime vessel and moving it with the trolley (8) of the crane (2);

3. moving the cover and placing it on the installed base in the body of the crane;

4. once the operation of loading and/or unloading of the crane is over returning the cover to the ship moving it from the said base to the ship.

1. System (1) for loading and unloading in port operations and supporting hatch covers (11) of holds of maritime vessels, WHEREIN it comprises:
a) a crane (2) for loading and unloading of maritime operations; and
b) a base located in the body of the crane to hold and stack hatch covers (11)

2. System (1) for loading and unloading in port operations and supporting hatch covers of holds of maritime vessels according to claim 1, WHEREIN the crane has horizontal lateral beams (7) one on each side of the body the crane and two legs (5) with angled shaped arch (15), each formed by two verticals profiles and a horizontal profile base (6).

3. System (1) for loading and unloading in port operations and supporting hatch covers of holds of maritime vessels according to claim 2, WHEREIN the base is an inner or outer platform (3, 12).

4. System (1) for loading and unloading in port operations and supporting hatch covers of holds of maritime vessels according to claim 2, WHEREIN the base is an inner or outer cover support (16, 13).

5. System (1) for loading and unloading in port operations and supporting hatch covers of holds of maritime vessels according to claim 3, WHEREIN in the main body of the crane is installed a rear horizontal beam (9) attached to the vertical profiles of the rear leg; a front horizontal beam (10) attached to the lateral horizontal beams (7).

6. System (1) for loading and unloading in port operations and supporting hatch covers of holds of maritime vessels according to claim 5, WHEREIN the platform (3) that is installed on the inside of the body of the crane is mounted on supports attached to the lateral horizontal beams (7) and on the rear and front horizontal beams.

7. System (1) for loading and unloading in port operations and supporting hatch covers of holds of maritime vessels according to claim 3, WHEREIN the outer platform (12) that is installed on the outside of the body of the crane is mounted on supports attached to the vertical profiles of the legs of the crane; and that it further comprises of some higher tensors (14) attached to the top of the crane.

8. System (1) for loading and unloading in port operations and supporting hatch covers of holds of maritime vessels according to claim 4, WHEREIN the cover support (16) installed on the inside of the body of the crane is formed by supports attached to the lateral horizontal profiles.

9. System (1) for loading and unloading in port operations and supporting hatch covers of holds of maritime vessels according to claim 4, WHEREIN the outer cover support (12) which is installed on the outside of the body of the crane is formed by supports attached to the vertical profiles of the legs of the crane; and that it further comprises of some higher tensors (14) attached to the top of the crane.

10. Procedure for removing, stacking and returning hatch covers in a system (1) for loading and unloading in port operations and supporting hatch covers of holds of maritime vessels according to claim 4, WHEREIN it comprises of:
I) having a system (1) for loading and unloading and supporting hatch covers which comprises:
a) a crane (2) for loading and unloading in port operations; and
b) a base located in the body of the crane to hold and stack the hatch covers;
II) removing the hatch cover from the hold of the maritime vessel and moving it with the trolley (9) of the crane;
III) moving the cover and placing it on the installed base in the body of the crane; and
IV) returning the cover to the ship moving it from the said base to the ship, once the operation of loading and/or unloading is over.
